(19) United States
(12) Patent Application Publication
(10) Pub. No.: US 2013/0144587 A1
(43) Pub. Date: Jun. 6, 2013

(54) SCALABILITY EVALUATION DEVICE, SCALABILITY EVALUATION METHOD, AND SCALABILITY EVALUATION PROGRAM

(71) Applicants: Hiroshi Sakaki, Tokyo (JP); Takao Osaki, Tokyo (JP)

(72) Inventors: Hiroshi Sakaki, Tokyo (JP); Takao Osaki, Tokyo (JP)

(73) Assignee: NEC CORPORATION, Tokyo (JP)

(21) Appl. No.: 13/816,994

(22) PCT Filed: Aug. 16, 2011
(86) PCT No.: PCT/JP2011/068817

§ 371 Date: Feb. 14, 2013

(30) Foreign Application Priority Data
Aug. 18, 2010 (JP) 2010-183320

(51) Int. Cl. G06F 17/50

(52) U.S. Cl. CPC G06F 17/5009
USPC 703/13

(57) ABSTRACT

A scalability evaluation device comprises planning means for receiving a request model, which is change prediction information of a request to a system and changing a scaling point, which is a configuration of the system which satisfies a condition for each of periods of the request model based on a predetermined rule, scaling cost calculation means for calculating a scaling cost, which is a cost required for changing the scaling point and outputting the scaling cost, and performance calculation means for calculating a performance value, which is a value representing a performance of the system when the scaling point is changed by the planning means and outputting the performance value.

### TECHNICAL FIELD

The present invention relates to a scalability evaluation device, a scalability evaluation method, and a scalability evaluation program.

### BACKGROUND ART

In regard to this field, in patent document 1, it is described that a design support system of an IT system creates a system plan satisfying a design reference value of a processing performance based on data required to design the IT system in a processing performance evaluation unit.

In patent document 2, it is described that a context-aware server performance evaluation system controls an evaluation module and evaluates the scalability, the processing speed, and the stability of a context-aware server.

In patent document 3, a performance evaluation device performance evaluation device including a performance evaluation unit for evaluating a performance of a development target system with respect to each of a processing time required to perform an action and a waiting time is described.

### PRIOR ART DOCUMENT

### Patent Document

[patent document 1] Japanese Patent Application Laid-Open No. 2005-316696
[patent document 2] Japanese Patent Application Laid-Open No. 2009-123195
[patent document 3] Japanese Patent Application Laid-Open No. 2009-205541

### BRIEF SUMMARY OF THE INVENTION

### Problems to be Solved by the Invention

However, the above-mentioned technology has a problem in which the scalability of the system cannot be evaluated based on variation of a request to the system.

For this reason, an object of the present invention is to provide a scalability evaluation device which can solve the above-mentioned problem and evaluate the scalability of the system based on the variation of the request to the system, a scalability evaluation method, and a scalability evaluation program.

### Solution to Problem

In order to achieve the objective, one aspect of the present invention is a scalability evaluation device which comprises:

A scalability evaluation device comprising:

planning means for receiving a request model, which is change prediction information of a request to a system and changing a scaling point, which is a configuration of said system which satisfies a condition for each of periods of said request model based on a predetermined rule,

scaling cost calculation means for calculating a scaling cost, which is a cost required for changing said scaling point and outputting said scaling cost, and

performance calculation means for calculating a performance value, which is a value representing a performance of the system when said scaling point is changed by said planning means and outputting said performance value.

Further, according to the present invention, provided is a scalability evaluation method comprising: receiving a request model, which is change prediction information of a request to a system and changing a scaling point, which is a configuration of said system which satisfies a condition for each period of said request model based on a predetermined rule,

calculating a scaling cost, which is a cost required for changing said scaling point and outputting said scaling cost, and

calculating a performance value, which is a value representing a performance of the system when said scaling point is changed and outputting said performance value.

Still further, according to the present invention, provided is a scalability evaluation program for causing a computer to execute:

a planning step in which a request model, which is change prediction information of a request to a system is received and a scaling point, which is a configuration of said system which satisfies a condition for each of periods of said request model is changed based on a predetermined rule,

a scaling cost calculation step in which a scaling cost, which is a cost required for changing said scaling point is calculated and outputted, and

a performance calculation step in which a performance value, which is a value representing a performance of the system when said scaling point is changed is calculated and outputted.

### Effect of the Invention

The present invention provides a scalability evaluation device which can evaluate the scalability of the system based on the variation of the request to the system, a scalability evaluation method, and a scalability evaluation program.

### BRIEF DESCRIPTION OF THE DRAWINGS

FIG. 1 is a block diagram showing a configuration according to a first exemplary embodiment.

FIG. 2 is a figure showing an operation of a first exemplary embodiment.

FIG. 3 is a block diagram showing a configuration according to a second exemplary embodiment.

FIG. 4 is a figure showing an operation of a second exemplary embodiment.

FIG. 5 is a block diagram showing a configuration according to a third exemplary embodiment.

FIG. 6 is a figure showing an operation of a third exemplary embodiment.

FIG. 7 is a figure showing an example of data stored in a configuration change cost storage block 5.

FIG. 8 is a figure showing an example of model information stored in a model storage block 1.

FIG. 9 is a figure showing an example of a request model.

FIG. 10 is a figure showing an example of data stored in a cost/performance data storage block 7.

FIG. 11 is a figure showing an example of a scalability evaluation value stored in a scalability evaluation value storage block 9.

FIG. 12 is a figure showing an example of a situation-specific request model.

FIG. 13 is a figure showing an example of a request model variation knowledge stored in a request model variation knowledge storage block 23.

FIG. 14 is a figure showing an example of data stored in a situation-specific countermeasure level storage block 11.

FIG. 15 is a figure showing an example of data stored in a correspondence knowledge storage block 12.

FIG. 16 is a figure showing an example of an operation service level stored in an operation service level storage block 10.

FIG. 17 is a figure showing an example of a request model (synthesis model) that is a result synthesized by an expected traffic synthesis block 14.

FIG. 18 is a block diagram showing a configuration according to a fourth exemplary embodiment.

FIG. 19 is an example of a storage unit by which a change in a condition of a request and a configuration of a system that can respond to it are associated with each other and stored.

### Mode for Carrying Out the Invention

Hereinafter, an exemplary embodiment of the present invention will be described by using drawings. The same reference numbers are used for the elements having the same function in all the drawings and the description is omitted appropriately.

Each block of which a scalability evaluation device 100 according to each exemplary embodiment is composed of a control unit, a memory, a program loaded in the memory, a storage unit such as a hard disk or the like for storing the program, an interface for network connection, and the like and realized by an arbitrary combination of hardware and software. In the absence of description, an arbitrary method for realizing it and an arbitrary device can be used.

The control unit is composed of a CPU (Central Processing Unit) and the like, controls the entire scalability evaluation device 100 by operating an operating system, reads out the program and the data from a recording medium mounted in for example, a drive device and stores it to the memory, and executes various processes according to this.

The recording medium is for example, an optical disk, a flexible disk, a magnetic optical disk, an external hard disk, a semiconductor memory, or the like and records a computer program so as to be computer-readable. The computer program may be downloaded from an external computer (not shown) connected to a communication network. Further, the communication network may be Internet, a LAN (Local Area Network), a public line network, a wireless communication network, a network composed of a combination of these networks, or the like.

The block diagram used for explanation of each exemplary embodiment is a functional block diagram and each block does not represent a hardware unit. These functional blocks are realized by an arbitrary combination of hardware and software. Further, in these figures, a configuration block according to each exemplary embodiment may be shown so as to be realized by one device in which a plurality of devices are physically connected. However, means for realizing this is not limited to the described means. Namely, two or more physically separated devices are connected by a wire line or a wireless line and by using these plurality of devices, each configuration block, the device, or the system of each exemplary embodiment may be realized. There is a case in which each configuration block is described as two or more physically separated devices. However, means for realizing this is not limited to the described means. Namely, each configuration block, the device, or the system according to each exemplary embodiment may be realized by arbitrarily combining hardware and software so as to be realized by one device in which two or more devices are physically combined.

### Exemplary Embodiment 1

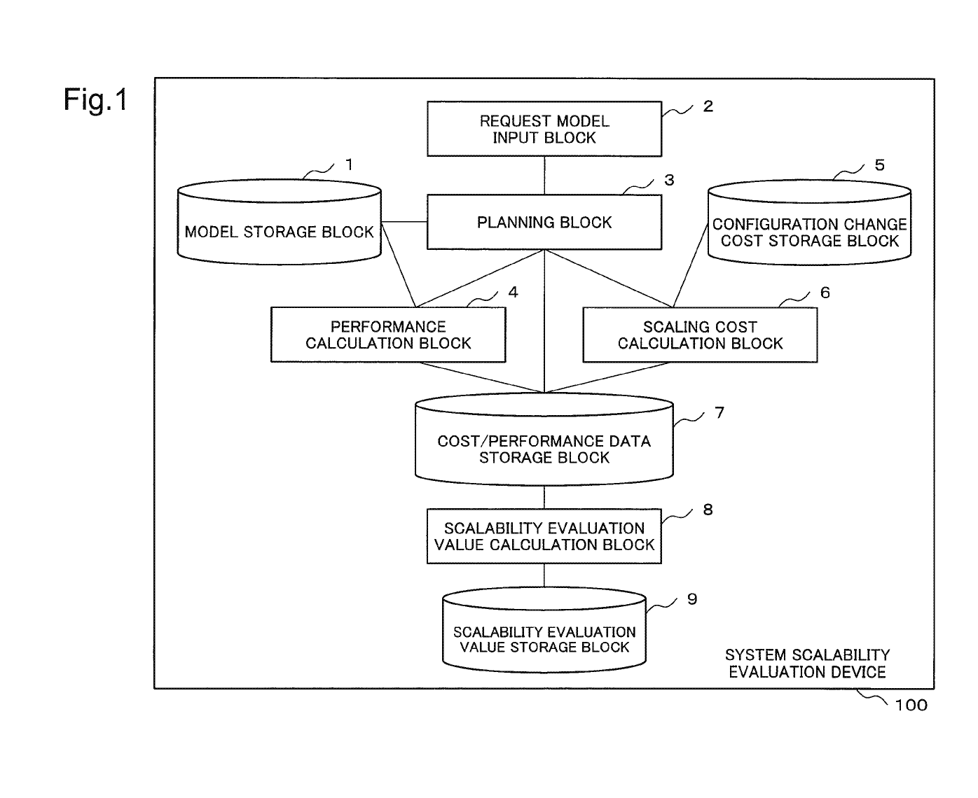

Next, a first exemplary embodiment for carrying out the invention will be described in detail with reference to FIG. 1.

Referring to FIG. 1, the scalability evaluation device 100 according to the first exemplary embodiment of the present invention includes a model storage block 1, a request model input block 2, a planning block 3, a performance calculation block 4, a configuration change cost storage block 5, a scaling cost calculation block 6, a cost/performance data storage block 7, a scalability evaluation value calculation block 8, and a scalability evaluation value storage block 9.

These blocks will be described.

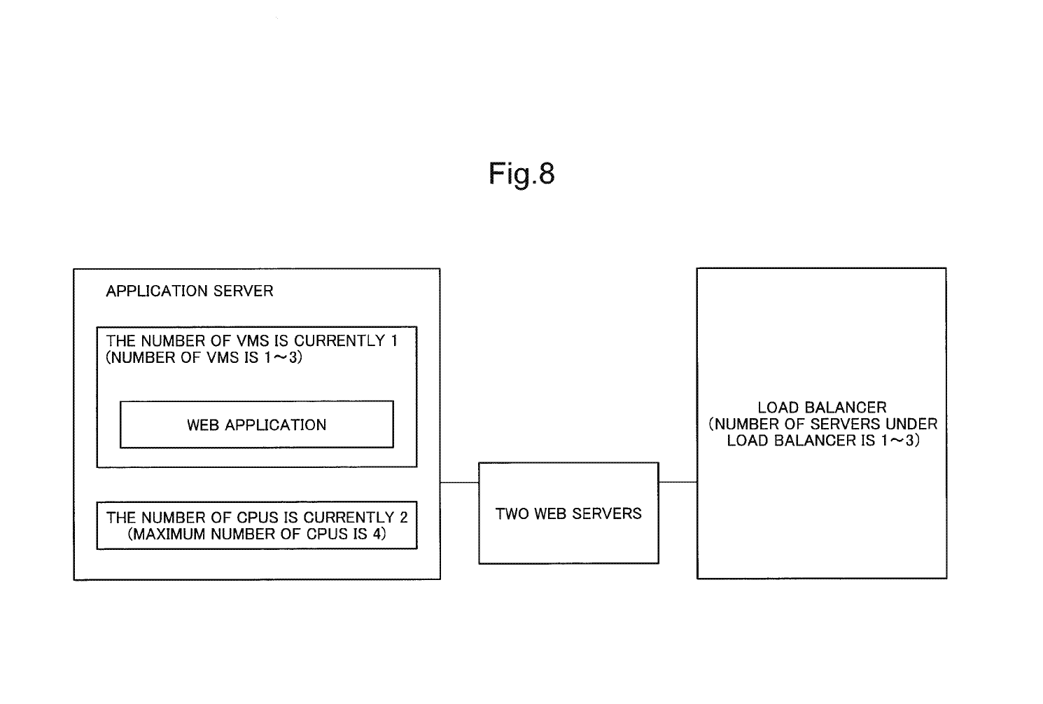

The model storage block 1 stores model information in which a configuration of a system and its operation are modeled. Here, the model information is information required for simulation such as information on a configuration of a server as described in FIG. 8 and information on an application included in it, a scalable configuration of it and a scalable range, a resource consumption amount (CPU (Central Processing Unit) usage rate or the like) of each server, and the like. It is described by a standard model description language such as a UML (Unified Modeling Language) or the like.

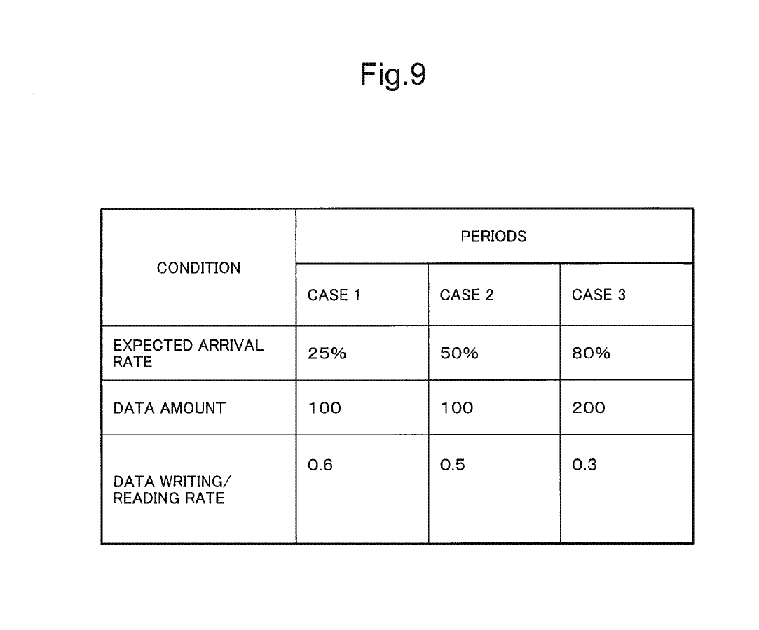

The request model input block 2 receives a request model in which a change of utilization situation of the system is described. Here, the utilization situation of the system is a situation of request to the system, traffic of the system, or the like. As shown in for example, FIG. 9, in the request model, the change of the utilization situation of the system over time is indicated by using one or more data among an expected arrival rate of the request, a data amount, and a data writing/reading rate (“condition” of the request model). FIG. 9 shows that the conditions of the request model changes over time, Case 1, Case 2, and Case 3 (“periods” of the request model) in this order. In FIG. 9, the expected arrival rate of the request, the data amount included in the request, and the data writing/reading rate are given for each Case (each period).

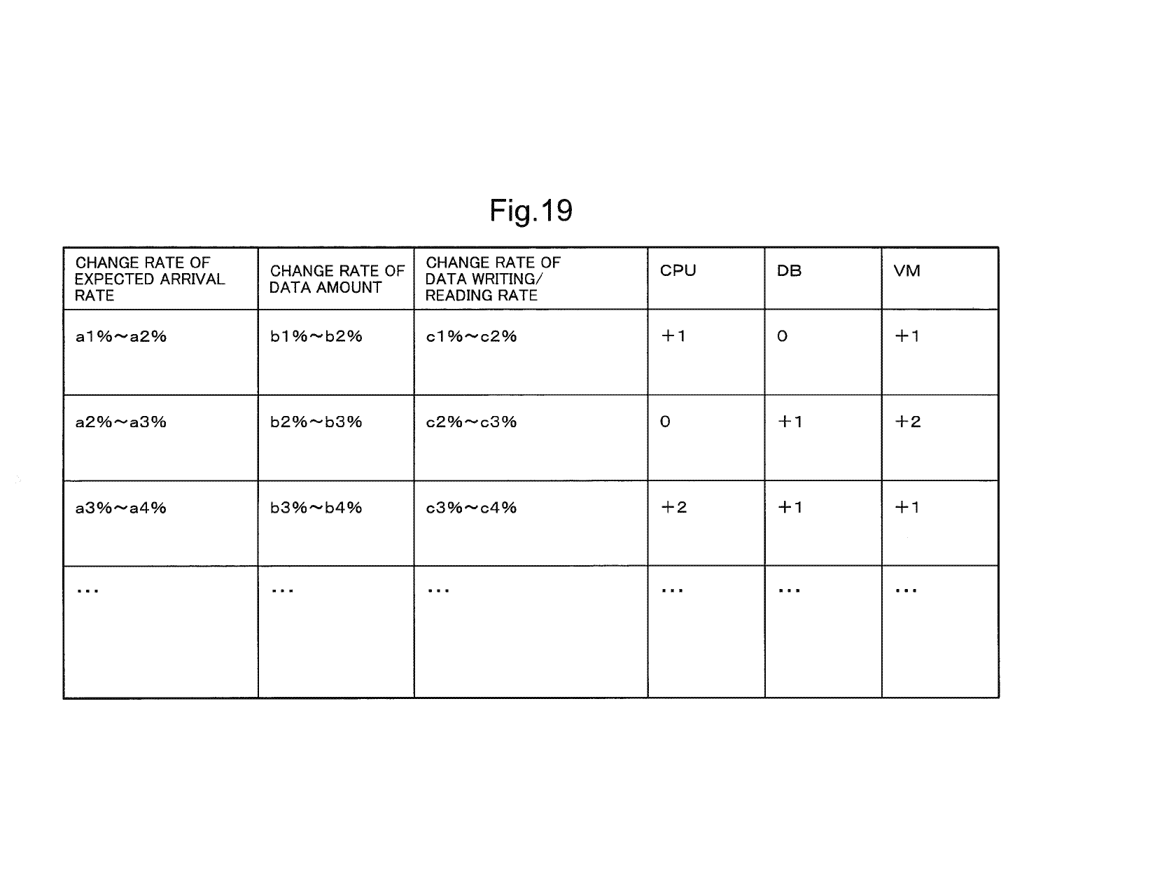

The planning block 3 determines a place at which the model is scaled up so as to satisfy the received request. Specifically, the planning block 3 determines a variable configuration place (scaling point) included in the model so that the model stored in the model storage block 1 can respond to the time change required by each request model received in the request model input block 2 and outputs a scaling content to the performance calculation block 4. For example, the planning block 3 acquires information on the change of the utilization situation of the system over time from the request model and determines the place (the number of CPUs, the number of DBs (Databases), and the number of VMs (Virtual Machines)) at which the configuration of the system has to be changed in order to respond to the time change based on a load which changes by the request, a processing ability of each configuration, and the like through a calculation. For example, the planning block 3 may determine a system configuration place which meets a change condition of the request model by using a predetermined function (that is, a predetermined function f represented by a function of f((expected arrival rate, data amount, data writing/reading rate))=(the number of CPUs, the number of DBs, the number of VMs) which outputs a vector (the number of CPUs, the number of DBs, the number of VMs) whose components are the number of the CPUs, the number of the DBs, the number of the VMs, and the like that are the numbers of the components of which the system is composed by using a load to the system that changes by the request or a vector (expected arrival rate, data amount, data writing/reading rate) whose components are the conditions such as the expected arrival rate, the data amount, the data writing/reading rate, and the like of the request model as an input. This function can be appropriately set according to an empirical rule by a user. Further, the planning block 3 may refer to a storage unit by which the utilization situation of the system, a change in the request, and the configuration of the system which can respond to the change are associated with each other and stored and determine the system configuration place that meets a change condition of the request model. An example of a table stored in such storage unit is shown in FIG. 19. For example, in a first row of the table shown in FIG. 19, it is shown that when a change rate of the expected arrival rate is a1% to a2%, a change rate of the data amount is b1% to b2%, and a change rate of the data writing/reading rate is c1% to c2% when Case (period) of the request model changes, the numbers of the CPUs, the numbers of the VMs, and the numbers of DBs that have to be changed are +1, +1, and 0 (in other words, it is not necessary to change the number of the DBs), respectively. The user can appropriately set the number of a1, a2, b1, b2, c1, c2, or the like representing the change rate according to the empirical rule.

The performance calculation block 4 evaluates a performance when the device is scaled up. Specifically, the performance calculation block 4 applies the content of scale-up of the configuration that is outputted by the planning block 3 to the model and calculates the performance (a value obtained by quantifying a processing ability such as a possible calculation amount, a calculation speed, or the like, a performance value for example, the number of requests that can be processed per second, or the like) of the system that is obtained from the number of the CPUs, the number of the DBs, and the number of the VMs of the system whose configuration is changed. For example, the performance calculation block 4 may obtain the performance of the system by using a predetermined function (that is, a predetermined function g represented by a function of g((number of CPUs, number of DBs, number of VMs))=system performance value) which outputs the performance value of the system by using a vector (number of CPUs, number of DBs, number of VMs) whose components are the numbers of the components of which the system is composed. This function can be appropriately set according to an empirical rule by the user. Further, the performance calculation block 4 may refer to the storage unit (not shown) by which the configuration of the system and the performance of the system are associated with each other and stored and obtain the performance of the system.

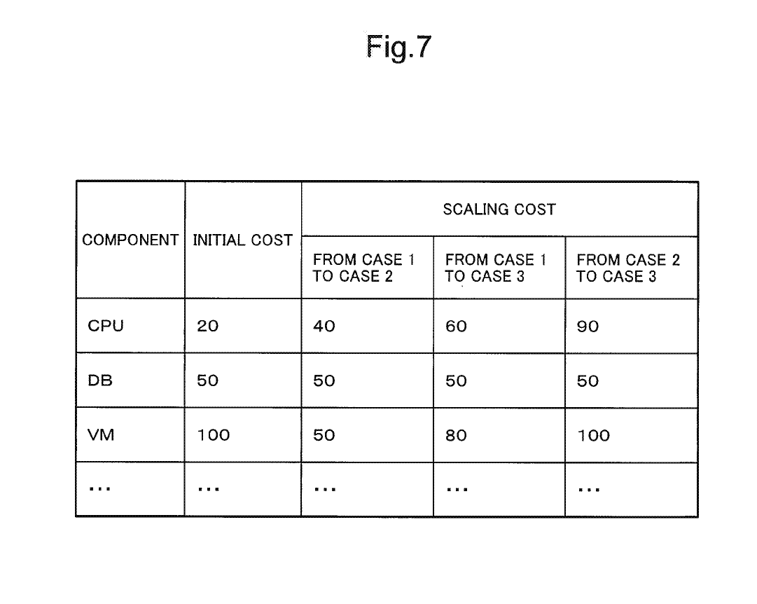

The configuration change cost storage block 5 stores the cost required when the device is configured and scaled up. Specifically, a component to be changed when the device is scaled up, an initial cost (a cost required for establishing a configuration that satisfies the condition of each Case (period) of the request model from the beginning), and the cost required for changing the component at the time of scaling up are associated with each other and stored by the configuration change cost storage block 5. An example of the data stored in the configuration change cost storage block 5 is shown in FIG. 7.

The scaling cost calculation block 6 calculates the cost (scaling cost) required for scaling up the scaling point based on the cost stored in the configuration change cost storage block 5. Specifically, the scaling cost calculation block 6 extracts the cost required for changing the configuration for each configuration of the scaling point from the configuration change cost storage block 5 and calculates the cost required for scaling up the scaling point.

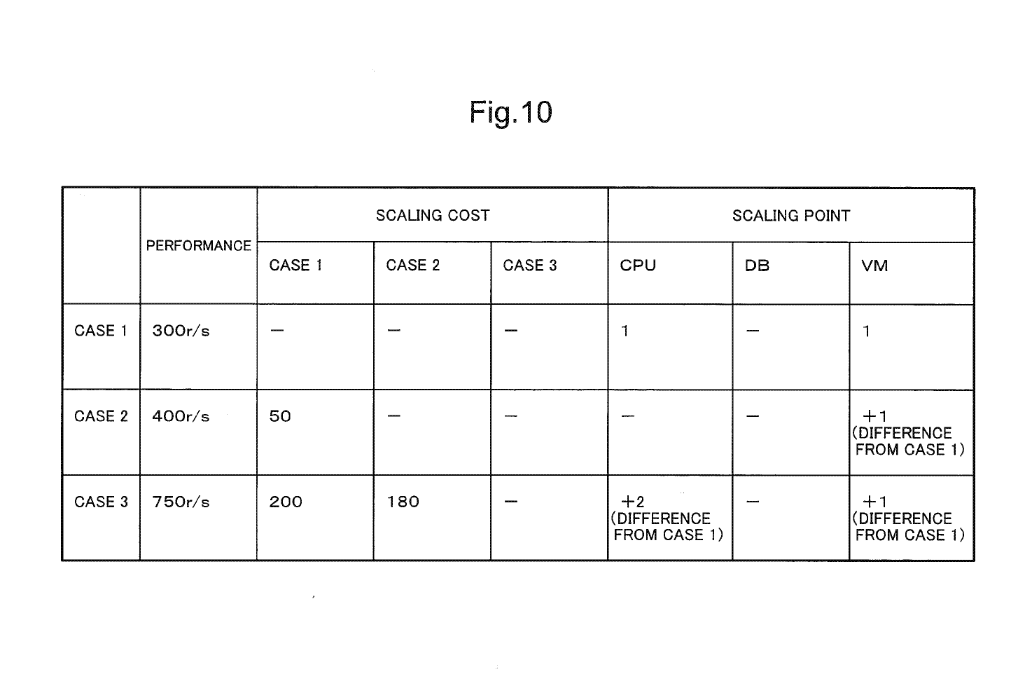

The cost/performance data storage block 7 stores the calculated cost and performance. Specifically, the cost/performance data storage block 7 stores the scaling point calculated by the planning block 3, the performance calculated by the performance calculation block 4, and the scaling cost calculated by the scaling cost calculation block 6. An example of the data stored in the cost/performance data storage block 7 is shown in FIG. 10. The scaling point column of FIG. 10 shows that in Case 1, the system is configured with one CPU and one VM. In Case 2, the entry of the VM column is “+1”. Namely, it means that the number of the VMs in Case 2 has to be increased by one from the number of the VMs in Case 1. In Case 3, the entry of the CPU column is “+2” and the entry of the VM column is “+1”. Namely, it means that the number of the CPUs and the number of the VMs have to be increased by two and one from Case 1, respectively.

The scalability evaluation value calculation block 8 calculates the scalability evaluation value for each request data from the data stored in the cost/performance data storage block 7. Specifically, the scalability evaluation value calculation block 8 calculates the scalability evaluation value for each request included in the request model by using the performance of the system and the scaling cost that are stored in the cost/performance data storage block 7. For example, the scalability evaluation value calculation block 8 may calculate the scalability evaluation value by using a formula: scalability evaluation value=(improved performance/cost). Further, the scalability evaluation value may be an evaluation value whose value is large when the improved system performance value is large and the required cost is small or an evaluation value whose value is small when the improved system performance value is small and the required cost is large. Especially, the scalability evaluation value is not limited.

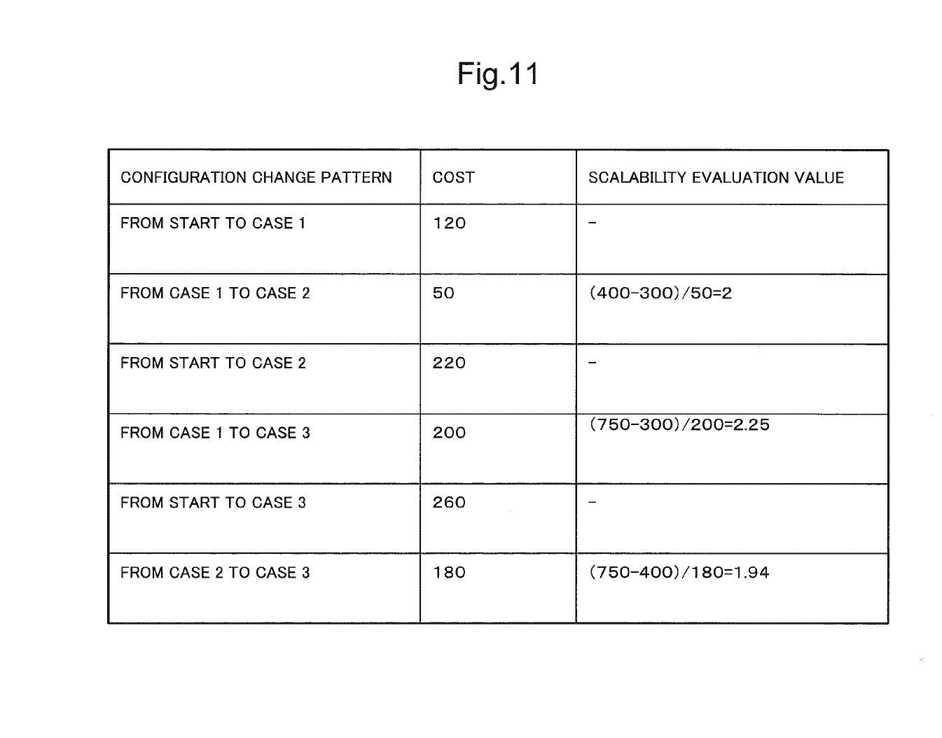

The scalability evaluation value storage block 9 stores the scalability evaluation value for each change pattern of each configuration that is calculated by the scalability evaluation value calculation block 8. An example of the scalability evaluation value stored by the scalability evaluation value storage block 9 is shown in FIG. 11.

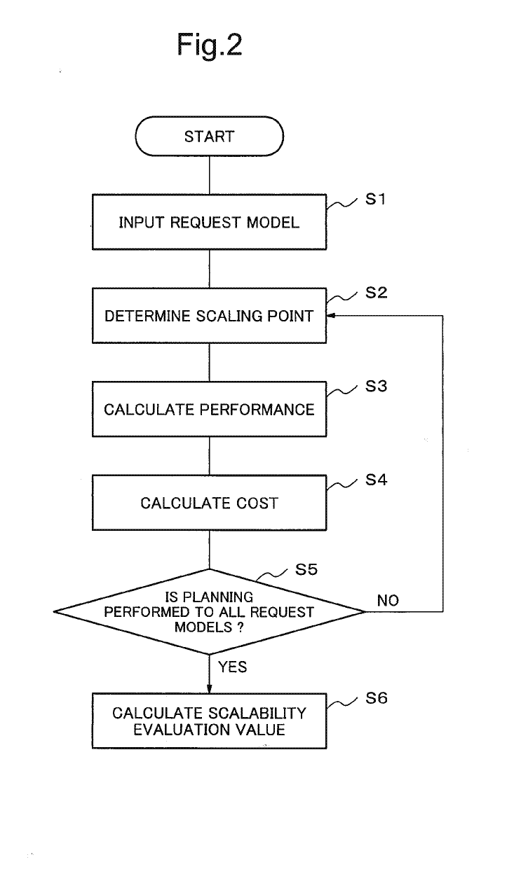

Next, an example of an entire operation of the exemplary embodiment will be described in detail with reference to the flowchart shown in FIG. 2.

First, the request model input block 2 receives the request model (step S1 in FIG. 2). Next, the planning block 3 applies the received request model to the model stored in the model storage block 1 and determines the scaling point from the system configuration which can deal with the received request (step S2 in FIG. 2). Additionally, the performance calculation block 4 applies the scaling point to the model and calculates the performance of the system (step S3 in FIG. 2). Further, the scaling cost calculation block 6 calculates the cost required for generating the scaled-up system by using the configuration change cost data stored in the configuration change cost storage block 5 (step S4 in FIG. 2). When the planning block 3 does not perform the planning to all the received request models, the scalability evaluation device 100 repeats the processes from step S2 to step S4 (step S5 in FIG. 2). When the planning block 3 performs the planning to all the received request models, the scalability evaluation value calculation block 8 calculates the scalability evaluation value based on the calculated cost and the performance of the system (step S6 in FIG. 2).

Next, the effect of the exemplary embodiment will be described.

The scalability evaluation device 100 according to the exemplary embodiment obtains the scaling point of the system according to the received request model and evaluates the scalability. Accordingly, the scalability evaluation device 100 according to the exemplary embodiment can evaluate the scalability of the system that fits with the variation of the request to the system without designating the scaling point in advance.

### Exemplary Embodiment 2

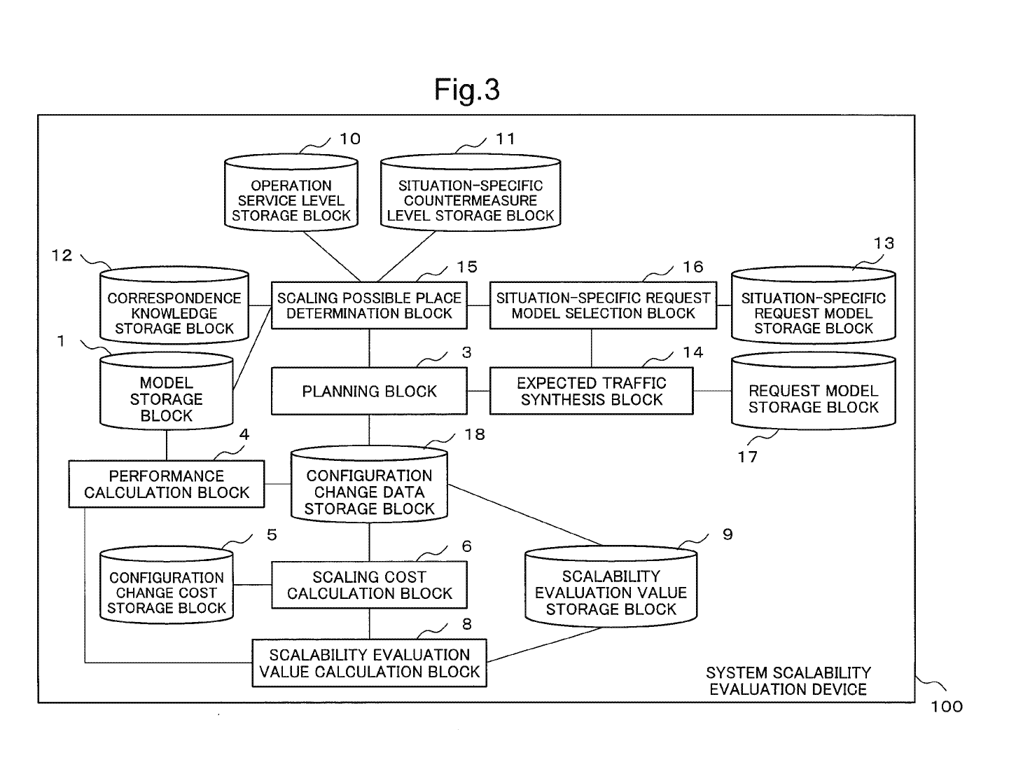

Next, a second exemplary embodiment of the present invention will be described in detail with reference to FIG. 3.

Referring to FIG. 3, the scalability evaluation device 100 according to the second exemplary embodiment of the present invention further includes an operation service level storage block 10, a situation-specific countermeasure level storage block 11, a correspondence knowledge storage block 12, a situation-specific request model storage block 13, an expected traffic synthesis block 14, a scaling possibility place determination block 15, a situation-specific request model selection block 16, a request model storage block 17, and a configuration change data storage block 18 for storing the scaling point in addition to the blocks included in the first exemplary embodiment. This is a difference between the configuration of the second exemplary embodiment and the configuration of the first exemplary embodiment.

These blocks will be described.

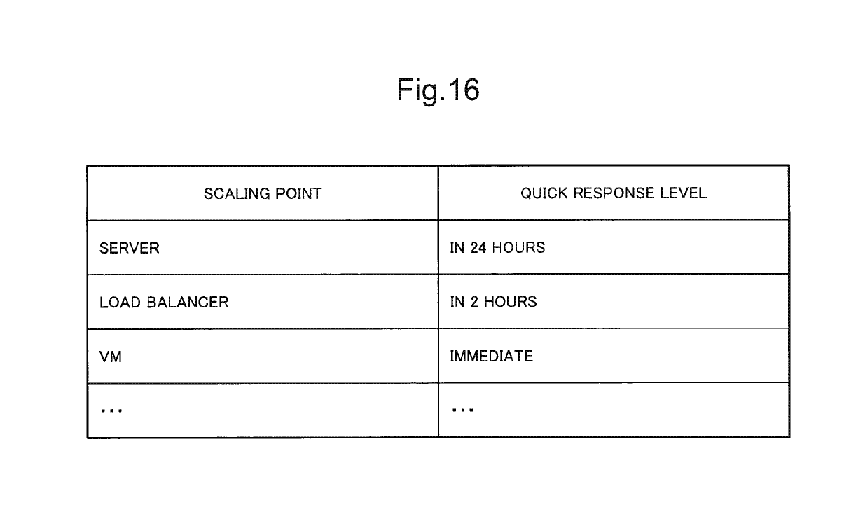

The operation service level storage block 10 stores the operation service level in which the operation time (quick response level) required for the scaling-up is described for each scaling point included in the model. The operation service level is a service level guaranteed by the system operation. Specifically, as shown in FIG. 16, the operation service level storage block 10 associates the scaling point with the quick response level and stores them.

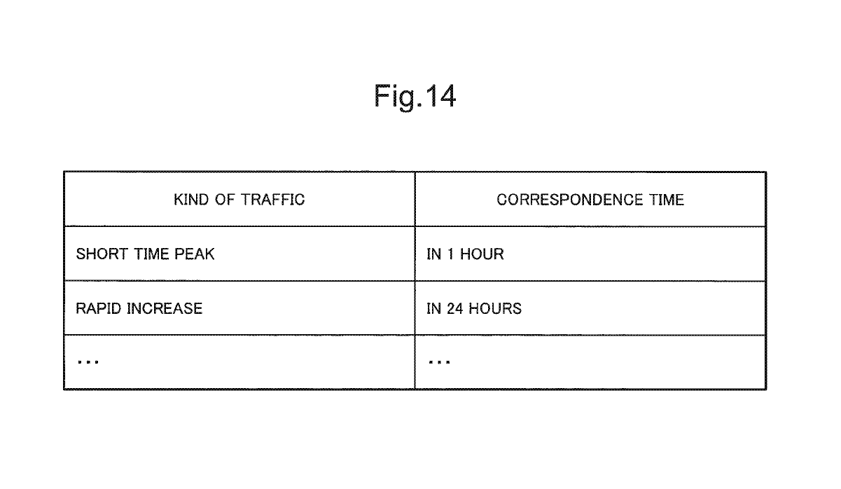

The situation-specific countermeasure level storage block 11 stores a situation-specific countermeasure level in which a time required for implementing the countermeasure to the system against a change in the request in a short time such as a change in the request to the system in a time of emergency is described. Specifically, as shown in FIG. 14, the situation-specific countermeasure level storage block 11 stores the situation-specific countermeasure level in which a correspondence time indicating an upper limit of time required for implementing the countermeasure to the system in the system operation against the change in traffic of the request by which the business content is not changed is described for each kind of traffic.

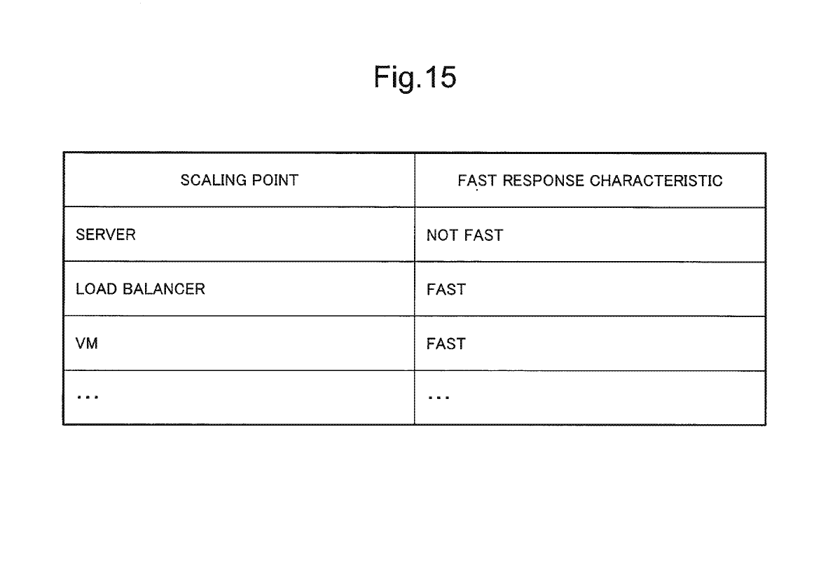

The correspondence knowledge storage block 12 stores the correspondence knowledge showing whether or not the countermeasure to each scaling point can be immediately implemented for each scaling point of which the model can be scaled up. Specifically, as shown in FIG. 15, the correspondence knowledge storage block 12 associates the scaling point of the model with information (fast response characteristic) of whether or not the countermeasure to each scaling point can be immediately (in a predetermined time) implemented on the system and stores them.

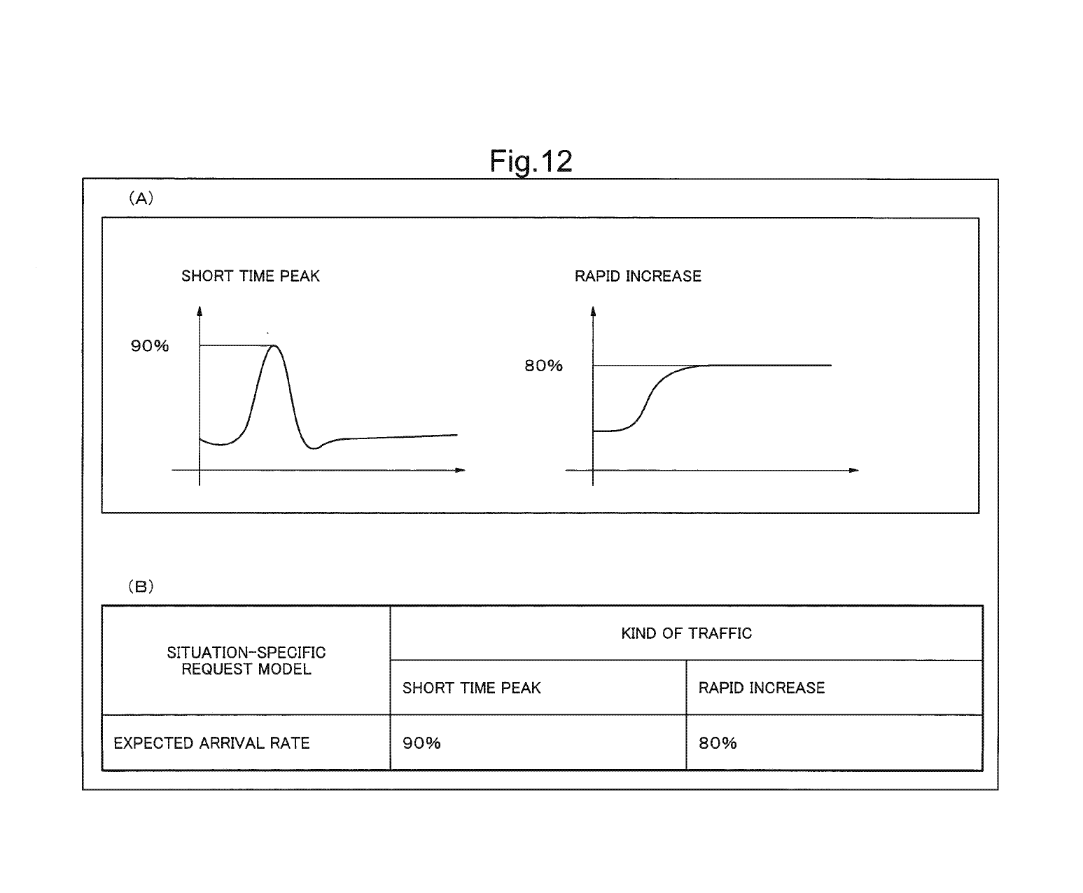

The situation-specific request model storage block 13 stores a situation-specific request in which the change in request in a short time that is caused by a reason other than a scaling-up of business is described. As the change in request (a kind of traffic) in a short time, for example, as shown in FIG. 12A, there is a “short time peak” of which the number of requests becomes large during a short time, a “rapid increase” of which the number of requests rapidly increases, or the like. As shown in FIG. 12, the situation-specific request model storage block 13 stores the situation-specific request model in which a traffic change situation is described for each kind of traffic with respect to the change in traffic of the request by which the business content is not changed.

The expected traffic synthesis block 14 creates a synthesis model in which the request model and the situation-specific request model are synthesized and receives it to the planning block 3. Specifically, the expected traffic synthesis block 14 obtains information on a period (in an example shown in FIG. 9, one of Case 1, Case 2, and Case 3) in which the situation-specific request occurs in the request model from the user and synthesizes the traffic of the period. The specific example will be described later.

The scaling possibility place determination block 15 determines the scaling point included in the model based on operation service level information (FIG. 16) according to the situation-specific request, correspondence time information (FIG. 14), and correspondence knowledge information (FIG. 15). Specifically, the scaling possibility place determination block 15 extracts the correspondence time corresponding to the kind of traffic in the situation-specific request model from the situation-specific countermeasure level storage block 11 (FIG. 14) and determines the scaling point of which the correspondence can be carried out in the correspondence time from at least one of the correspondence knowledge information shown in FIG. 15 and the operation service level information shown in FIG. 16. For example, an example in which the scaling possibility place determination block 15 determines a candidate for the scaling point by using the operation service level will be described. When the kind of traffic in the situation-specific request model is the “short time peak”, the correspondence time is “in 1 hour” (FIG. 14) and the quick response level of the VM is “immediate” (FIG. 16). Therefore, it is understood that a change in the number of the VMs can be performed in one hour. Accordingly, the scaling possibility place determination block 15 selects the VM as the scaling point. When there are a plurality of the scaling points of which the correspondence can be carried out, the scaling possibility place determination block 15 selects these scaling points as the candidate for the scaling point of which the scaling-up is actually performed.

The situation-specific request model selection block 16 selects one or more situation-specific request models used for the planning performed by the planning block 3 among the situation-specific request models stored in the situation-specific request model storage block 13. The situation-specific request model selection block 16 may automatically select the situation-specific request model by expecting the request to the system or the user may directly select the situation-specific request model.

The request model storage block 17 stores the request model indicating the change in the request over time that is expected according to the change in the business content or a growth in service. Because the request model has been described in the exemplary embodiment 1, the detail description will be omitted.

The other configuration of this exemplary embodiment is almost the same as that of the first exemplary embodiment. Therefore, the detail description is omitted but the outline will be described below. In the scalability evaluation device 100 according to the second exemplary embodiment, the planning block 3 determines the scaling point of the model so that the system can deal with the expected traffic. The performance calculation block 4 calculates the performance of the model of which the scaling point is reflected. The scaling cost calculation block 6 calculates the scaling cost by using the scaling point and the configuration change cost. The scalability evaluation value calculation block 8 calculates the scalability evaluation value from the performance and the scaling cost. The scalability evaluation value storage block 9 stores the calculated scalability.

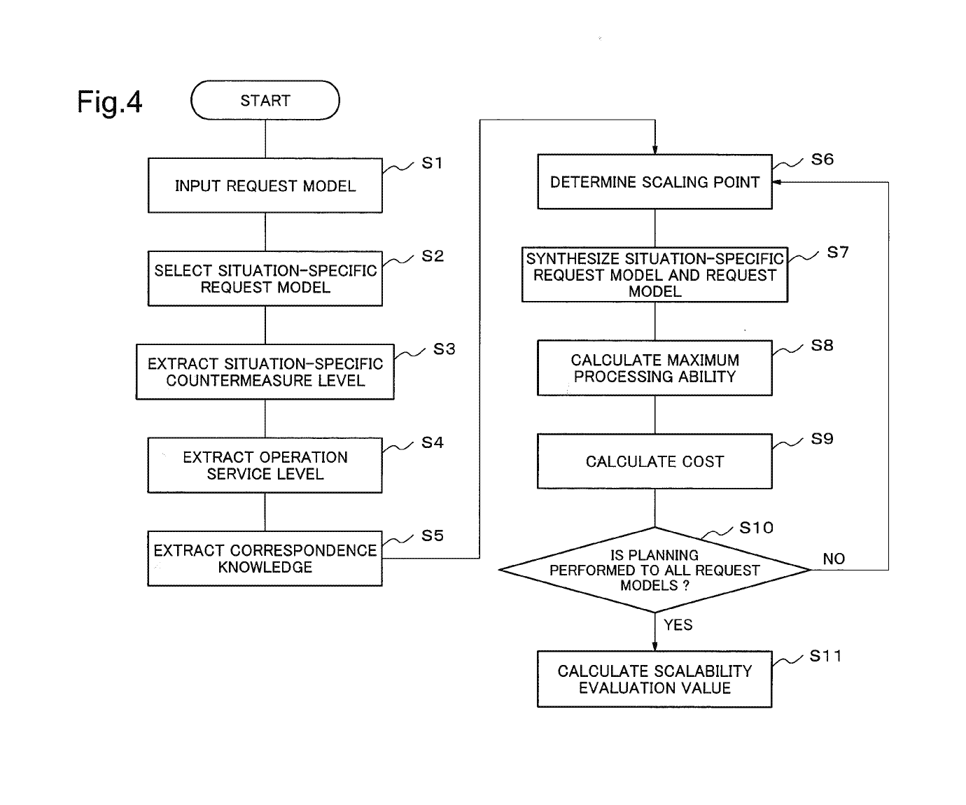

Next, an example of the entire operation of the exemplary embodiment will be described in detail by using the flowchart shown in FIG. 4.

First, the request model input block 2 (not shown) receives the request model (step S1 in FIG. 4). Next, the situation-specific request model selection block 16 selects the situation-specific request model from the situation-specific request model storage block 13 (step S2 in FIG. 4). Next, a scalability possible place determination block 15 extracts the situation-specific countermeasure level corresponding to the above-mentioned situation-specific request model from the situation-specific countermeasure level storage block 11 (step S3 in FIG. 4). Further, the scalability possible place determination block 15 extracts the operation service level corresponding to the above-mentioned situation-specific request model from the operation service level storage block 10 (step S4 in FIG. 4). Further, a scaling possible place determination block 15 extracts the correspondence knowledge corresponding to the above-mentioned situation-specific request model from the correspondence knowledge storage block 12 (step S5 in FIG. 4). The scaling possible place determination block 15 extracts the scaling point of which the correspondence can be carried out in the correspondence time based on the correspondence time (FIG. 14) of the above-mentioned situation-specific countermeasure level, the quick response level (FIG. 16) of the above-mentioned operation service level, and the fast response characteristic (FIG. 15) of the above-mentioned correspondence knowledge and specifies the candidate for the scaling point in the model (step S6 in FIG. 4). Further, the expected traffic synthesis block 14 synthesizes the selected situation-specific request model and the request model (step S7 in FIG. 4). Further, the planning block 3 determines the scaling point so as to satisfy the condition of the synthesized request model from the scaling point extracted by the scaling possible place determination block 15, stores it in the configuration change data storage block 18 as the configuration change data, and calculates the maximum processing ability of the configuration (step S8 in FIG. 4). Furthermore, the scaling cost calculation block 6 calculates the cost required for generating the scaled-up system (changing an original system) by using the generated system configuration and the configuration change cost data (step S9 in FIG. 4). When the planning block 3 does not perform the planning with respect to all the received request models, the scalability evaluation device 100 repeats the processes from step S8 to step S9 in FIG. 4 (step S10 in FIG. 4). When the planning block 3 performs the planning with respect to all the request models, the scalability evaluation value is calculated by the scalability evaluation value calculation block 8 based on the calculated cost and the performance and it is stored in the scalability evaluation value storage block 9 as the situation-specific scalability evaluation data (step S11 in FIG. 4).

Next, the operation of the exemplary embodiment will be specifically described.

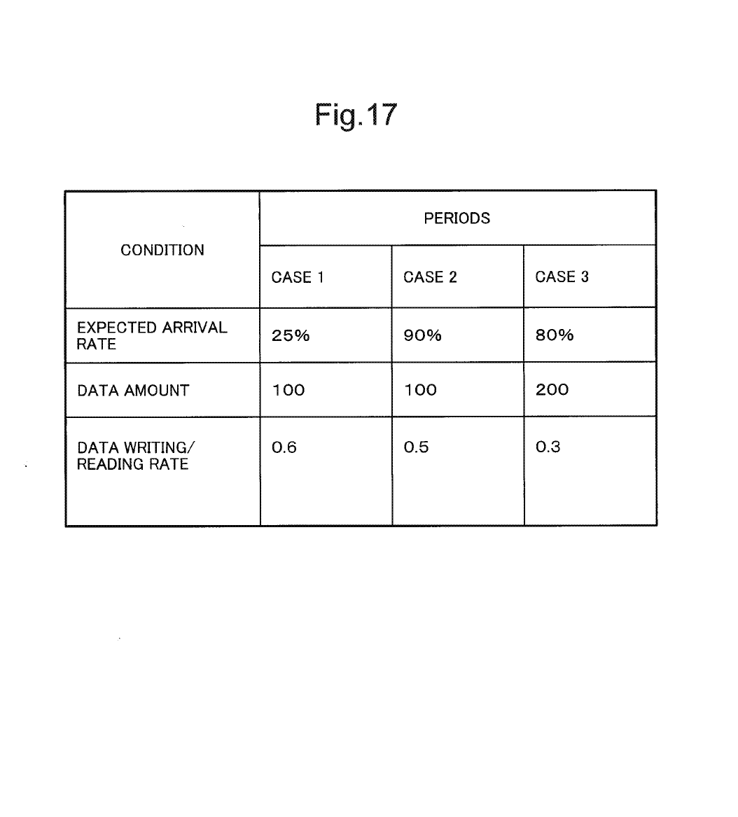

As shown in FIG. 8, the model information in which the configuration of the system, a point whose configuration can be scaled-up, and the operation are described as the model is stored in the model storage block 1. A specific example of evaluating the scalability of the model will be described by using FIG. 8. For example, it is shown in FIG. 8 that in the model, the VM is arranged in an application server and the number of the VMs that can be installed in the application server is one to three. Next, the request model shown in FIG. 9 is given by the request model input block 2. In FIG. 9, it is shown that the request model changes over time: Case 1, Case 2, and Case 3 in this order. The expected arrival rate of the request, the data amount included in the request, and a data writing/reading rate are given for each Case in FIG. 9. Next, the situation-specific request model shown in FIG. 12B is given by the situation-specific request model selection block 16. In the example, a case in which the kind of traffic shown in FIG. 12B is the expected arrival rate of the “short time peak” will be explained. The user designates a period in which the situation-specific request occurs in the request model. The designation is received and the expected traffic synthesis block 14 synthesizes the traffic. In this exemplary embodiment, a case in which the expected traffic synthesis block 14 synthesizes the situation-specific request model as Case 2 of the request model will be described as an example. In this case, in the request model that is a result of the synthesis performed by the expected traffic synthesis block 14, as shown in FIG. 17, the expected arrival rate of Case 2 becomes 90% of the expected arrival rate of the situation-specific request. This is a difference between this synthesized request model and the request model shown in FIG. 9. Next, the scaling possible place determination block 15 restricts the scaling point that is scalable in the model from the situation-specific countermeasure level (refer to FIG. 14). In the exemplary embodiment, the kind of traffic of the situation-specific request model is the “short time peak”. Therefore, the scaling possibility place determination block 15 extracts the correspondence time (in 1 hour) corresponding to the situation-specific request model of the short time peak from the situation-specific countermeasure level shown in FIG. 14. When the system of which the correspondence can be carried out in this correspondence time is determined from, for example, the operation service level (FIG. 16), the quick response level of the VM is “immediate”. Therefore, it is understood that the change in the number of the VMs can be performed in one hour. Accordingly, in the planning of Case 2, the planning block 3 limits the scaling point to this change in the number of the VMs and performs the planning. The planning result is shown in a scaling point column of FIG. 10 for each of periods of Case 1, Case 2, and Case 3. According to the planning result shown in FIG. 10, it is understood that in order to satisfy the request of Case 1, one CPU is required and in Case 2, the number of VMs that is the scaling point is +1, in other words, one VM has to be added. The scaling cost calculation block 6 calculates the cost required for the scaling-up from the planning result by referring to the configuration change cost storage block 5. The performance calculation block 4 calculates the performance of the system when the scaling-up is applied to the system. Next, the scalability evaluation value calculation block 8 calculates the scalability evaluation value by using a formula: for example, scalability evaluation value=(improved performance/cost). An example of the calculated scalability evaluation value is shown in FIG. 11. FIG. 11 shows the scalability evaluation value when the configuration is changed in three patterns: from Case 1 to Case 2, from Case 2 to Case 3, and from Case 1 to Case 3. In this example, the scalability evaluation device 100 determines that the scaling-up from Case 1 to Case 3 has the highest scalability and outputs its result.

Next, the effect of the exemplary embodiment will be described.

The scalability evaluation device 100 according to the exemplary embodiment restricts the element of the model which can respond to the situation-specific request from the situation-specific countermeasure level, the operation service level, and the countermeasure knowledge and calculates the scalability evaluation value by performing the planning of the model based on the traffic obtained by synthesizing the situation-specific request model and the request model. Therefore, the scalability evaluation device 100 according to the exemplary embodiment can perform the evaluation of the scalability of the system that fits with the request variation even when not only the system is usually scaled up but also the system is scaled up by a sudden request variation.

### Exemplary Embodiment 3

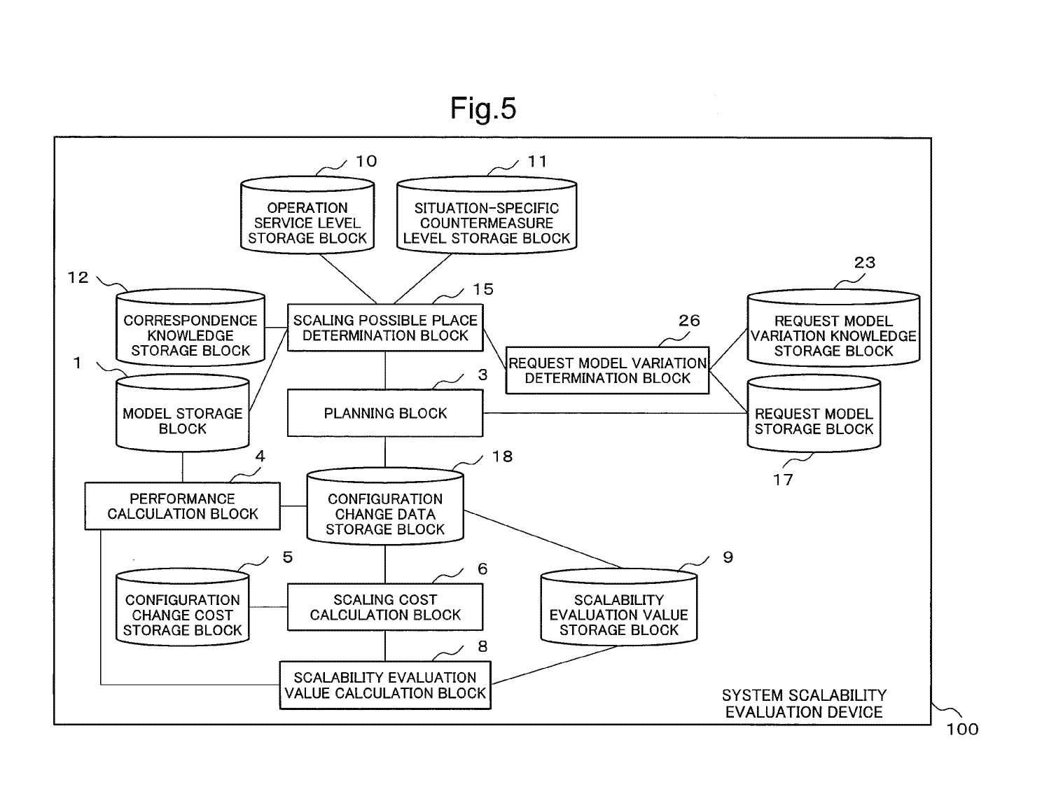

Next, a third exemplary embodiment of the present invention will be described in detail with reference to FIG. 5.

Referring to FIG. 5, the third exemplary embodiment of the present invention has a request model variation knowledge storage block 23 instead of the situation-specific request model storage block 13 according to the second exemplary embodiment of the present invention and has a request model variation determination block 26 instead of the situation-specific request model selection block 16. The blocks other than these blocks according to the third exemplary embodiment are the same as those of the first or second exemplary embodiment. Therefore, the detail description is omitted.

The above-mentioned blocks will be described.

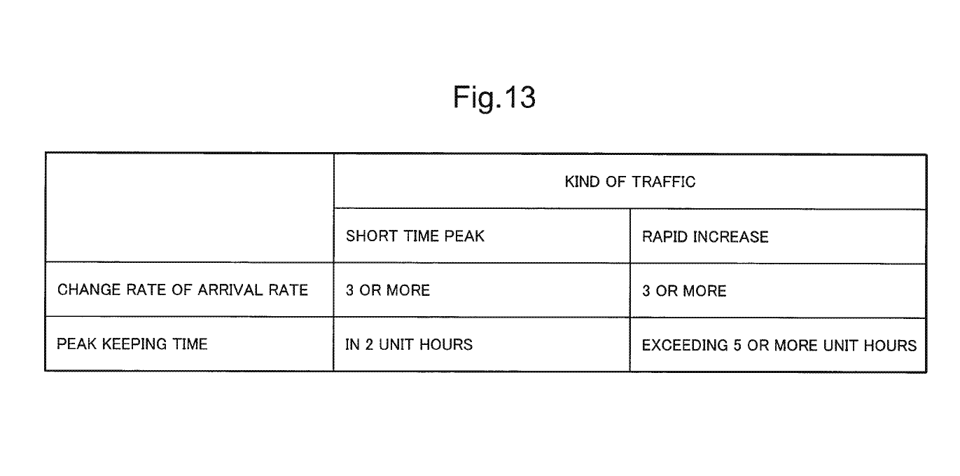

The request model variation knowledge storage block 23 stores a request model variation knowledge that is a knowledge for determining the situation of the request based on the change in the request such as an increasing rate of the request, an increasing duration, and the like. An example of the request model variation knowledge stored in the request model variation knowledge storage block 23 is shown in FIG. 13.

As shown in FIG. 13, for example, the request model variation knowledge storage block 23 associates the situation of which a change rate of the request arrival rate is 3 or more and a peak keeping time is within 2 hours with the situation of the request that is of the “short time peak” and stores them.

The request model variation determination block 26 determines a request model change situation (time change situation) based on the request model variation knowledge stored in the request model variation knowledge storage block 23 with respect to the received request model.

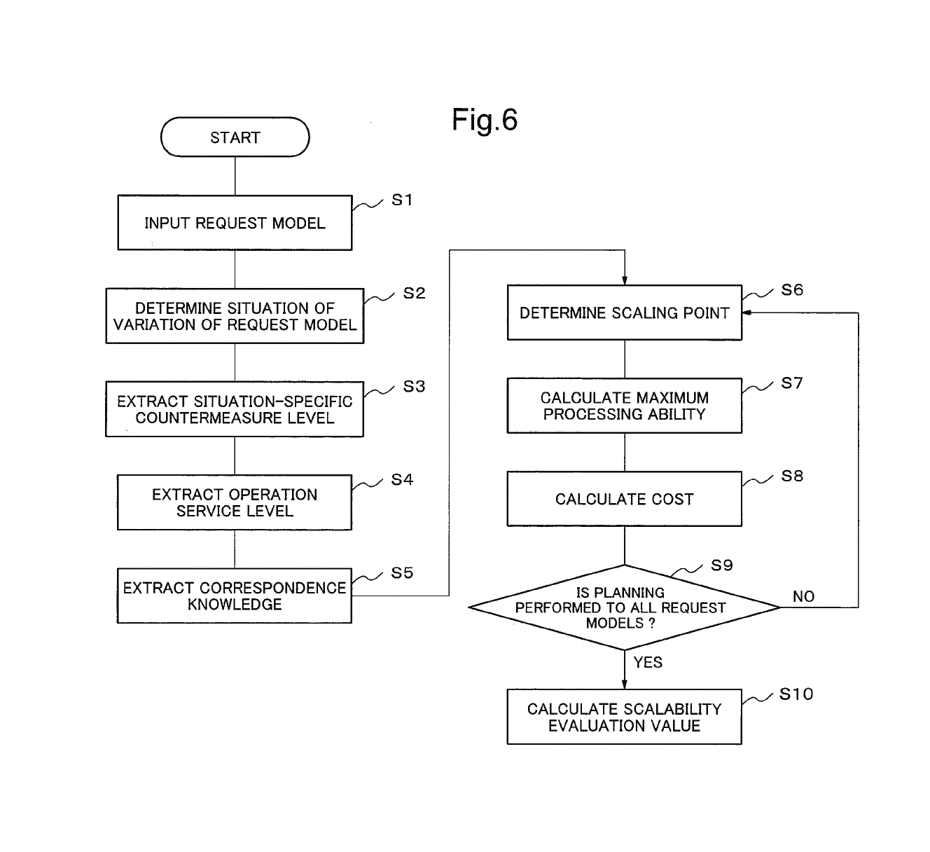

Next, an example of the entire operation of the exemplary embodiment will be described in detail with reference to the flowchart shown in FIG. 5 and FIG. 6.

First, the request model input block 2 (not shown) receives the request model (step S1 in FIG. 6). Next, the request model variation determination block 26 refers to the request variation knowledge stored in the request model variation knowledge storage block 23 and determines the situation of the variation of the received request model (step S2 in FIG. 6). The scaling possible place determination block 15 extracts the correspondence time of the situation-specific countermeasure level from the situation-specific countermeasure level storage block 11 according to the situation of the request model determined by the request model variation determination block 26 (step S3 in FIG. 6). The scaling possible place determination block 15 extracts the quick response level of the operation service level from the operation service level storage block 10 according to the situation of the request model (step S4 in FIG. 6). Further, the scaling possible place determination block 15 extracts the fast response characteristic of the correspondence knowledge from the correspondence knowledge storage block 12 according to the situation of the request model (step S5 in FIG. 6). The scaling possibility place determination block 15 extracts the candidate for the scaling point of which the correspondence can be carried out in the correspondence time from the correspondence time (refer to FIG. 14) of the situation-specific countermeasure level, the quick response level (refer to FIG. 16) of the operation service level, or the fast response characteristic (refer to FIG. 15) of the correspondence knowledge and specifies the candidate for the scaling point in the model (step S6 in FIG. 6). Further, the planning block 3 determines the scaling point which satisfies the request model from the candidates for the scaling point extracted by the scaling possible place determination block 15, stores it in the configuration change data storage block 18 as the configuration change data, and calculates the maximum processing ability of the configuration (step S7 in FIG. 6). Further, the scaling cost calculation block 6 calculates the cost required for configuring or changing the system by using the generated system configuration and the configuration change cost data (step S8 in FIG. 6). When the planning block 3 does not perform the planning with respect to all the received request models, the scalability evaluation device 100 repeats the processes from step S7 to step S8 (step S9 in FIG. 6). When the planning block 3 has performed the planning with respect to all the request models, the scalability evaluation value calculation block 8 calculates the scalability evaluation value based on the configuration change data and the configuration change cost and stores it in the scalability evaluation value storage block 9 as the situation-specific scalability evaluation data (step S10 in FIG. 4).

Next, the effect of the exemplary embodiment will be described.

The scalability evaluation device 100 according to the exemplary embodiment determines the change in the situation-specific request model based on the request variation knowledge, restricts the element on the model which can respond to the situation-specific request, determines the scaling-up of the system so as to satisfy the request model, and evaluates the scalability. Therefore, the scalability evaluation device 100 according to the exemplary embodiment can perform the evaluation of the scalability of the system that fits with the variation of the request to the system.

### Exemplary Embodiment 4

Next, a fourth exemplary embodiment of the present invention will be described.

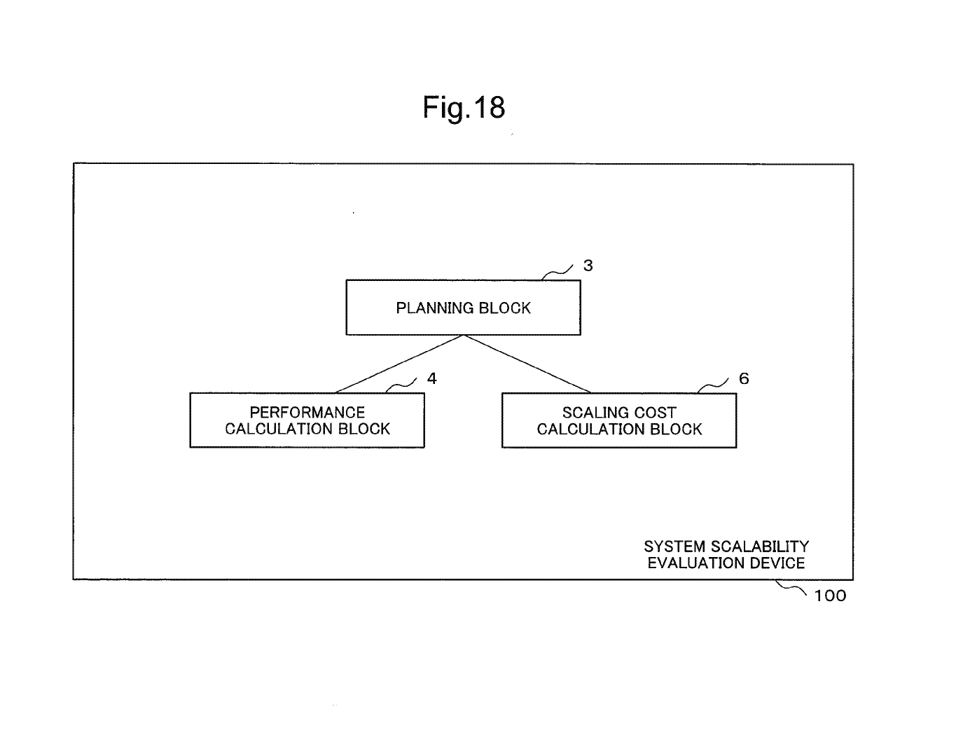

FIG. 18 is a figure showing a configuration of the fourth exemplary embodiment of the present invention. Referring to FIG. 18, the scalability evaluation device 100 according to the fourth exemplary embodiment of the present invention is composed of the planning block 3, the performance calculation block 4, and the scaling cost calculation block 6. Because the configuration and the operation of these blocks are the same as those of the first exemplary embodiment, the detail description is omitted.

By this configuration, the scalability evaluation device including planning means for determining the scaling point of the configuration of the system so as to satisfy the condition of the received request model, scaling cost calculation means for calculating the scaling cost required for changing the configuration of the system with respect to the scaling point and outputting it, and performance calculation means for calculating the performance value of the system when the scaling point determined by the planning means is changed and outputting it is provided.

The scalability evaluation device 100 according to the exemplary embodiment can evaluate the scalability based on the variation of the request to the system. The present invention provides a scalability evaluation device, a scalability evaluation method, and a program for evaluating scalability.

Although the invention of the present application has been described with reference to the exemplary embodiment above, the invention of the present application is not limited to the above-mentioned exemplary embodiment. Various changes in the configuration or details of the invention of the present application that can be understood by those skilled in the art can be made without departing from the scope of the invention.

This application claims priority based on Japanese Patent Application No. 2010-183320 filed on Aug. 18, 2010, the disclosure of which is hereby incorporated by reference in its entirety.

### DESCRIPTION OF SYMBOL

1 model storage block
2 request model input block
3 planning block
4 performance calculation block
5 configuration change cost storage block
6 scaling cost calculation block
7 cost/performance data storage block
8 scalability evaluation value calculation block
9 scalability evaluation value storage block
10 operation service level storage block
11 situation-specific countermeasure level storage block
12 correspondence knowledge storage block
13 situation-specific request model storage block
14 expected traffic synthesis block
15 scaling possibility place determination block
16 situation-specific request model selection block
17 request model storage block
18 configuration change data storage block
23 request model variation knowledge storage block
26 request model variation determination block
100 scalability evaluation device

1-10. (canceled)

11. A scalability evaluation device comprising:
a planning unit which receives a request model, which is change prediction information of a request to a system and changes a scaling point, which is a configuration of said system which satisfies a condition for each of periods of said request model based on a predetermined rule,
a scaling cost calculation unit which calculates a scaling cost, which is a cost required for changing said scaling point and outputs said scaling cost, and
a performance calculation unit which calculates a performance value, which is a value representing a performance of the system when said scaling point is changed by said planning unit and outputs said performance value.

12. The scalability evaluation device described in claim 11 further comprising:
an expected traffic synthesis unit which receives a second condition of said request to said system and one of said periods of said request model and outputs a synthesis model in which the condition in said received period of said request model is replaced with said second condition, wherein
said planning unit changes said scaling point which satisfies the condition for each of said periods of the request model determined by said synthesis model.

13. The scalability evaluation device described in claim 12 further comprising:
a situation-specific countermeasure level storage unit which stores a kind of traffic of the request model that is associated with said second condition and a correspondence time, which is an upper limit time representing a time in which the system responds to the kind of traffic,
an operation service level storage unit which stores the scaling point and a quick response level, which is a time required for changing the scaling point, and
a scaling possible place determination unit which refers to said correspondence time and said quick response level based on said kind of traffic and extracts a change place of the configuration which can be changed in said correspondence time from said operation service level storage unit as a candidate for said scaling point.

14. The scalability evaluation device described in claim 13 further comprising:
a request model variation knowledge storage unit which stores said kind of traffic and a change amount of the condition of said request model of said kind of traffic, and
a request model variation determination unit which refers to said request model variation knowledge storage unit and determines the kind of traffic from the change amount of the condition of said received request model,
wherein said scaling possible place determination unit, refers to said correspondence time and said quick response level based on the determined kind of traffic of said request model and extracts a change place which can be changed in said correspondence time from said operation service level storage unit as the candidate for the scaling point.

15. A non-transistory storage medium storing a scalability evaluation program which causes a computer to perform
a planning step in which a request model, which is change prediction information of a request to a system is received and a scaling point, which is a configuration of said system which satisfies a condition for each of periods of said request model is changed based on a predetermined rule,
a scaling cost calculation step in which a scaling cost, which is a cost required for changing said scaling point is calculated and outputted, and
a performance calculation step in which a performance value, which is a value representing a performance of the system when said scaling point is changed is calculated and outputted.

16. The non-transistory storage medium storing said scalability evaluation program described in claim 15 which causes a computer to perform
an expected traffic synthesis step in which a second condition of said request to said system and one of said periods of said request model are received and a synthesis model in which the condition in said received period of said request model is replaced with said second condition is outputted, wherein
said planning step in which said scaling point which satisfies the condition for each of said periods of the request model determined by said synthesis model is changed.

17. The non-transistory storage medium storing said scalability evaluation program described in claim 16 which causes a computer to further perform a scaling possible place determination step in which from the situation-specific countermeasure level storage unit which stores a kind of traffic of said situation-specific request model associated with said second condition and a correspondence time, which is an upper limit time representing a time in which the system responds to the kind of traffic and an operation service level storage unit which stores the scaling point and a quick response level, which is a time required for changing the scaling point, said correspondence time and said quick response level are referred to based on the kind of traffic of the request model and a change place of the configuration which can be changed in said correspondence time is extracted from said operation service level storage unit as a candidate for said scaling point.

18. The non-transistory storage medium storing said scalability evaluation program described in claim 17 which causes a computer to perform
a request model variation determination step in which request model variation knowledge storage unit, which stores said kind of traffic and a change amount of a condition of said request model of said kind of traffic, is referred to and the kind of traffic is determined from a change amount of the condition of said received request model and
said scaling possible place determination step in which said correspondence time and said quick response level are referred to based on the determined kind of traffic of said request model and a change place which can be changed in said correspondence time is extracted from said operation service level storage unit as the candidate for the scaling point.

19. A scalability evaluation method comprising the steps of:
receiving a request model, which is change prediction information of a request to a system and changing a scaling point, which is a configuration of said system which satisfies a condition for each of periods of said request model based on a predetermined rule,
calculating a scaling cost, which is a cost required for changing said scaling point and outputting said scaling cost, and
calculating a performance value, which is a value representing a performance of the system when said scaling point is changed and outputting said performance value.

20. The scalability evaluation method described in claim 19 further comprising the steps of:
receiving a second condition of said request to said system and one of said periods of said request model and outputting a synthesis model in which the condition in said received period of said request model is replaced with said second condition wherein
changing said scaling point which satisfies the condition for each of said periods of the request model determined by said synthesis model.

21. A scalability evaluation device comprising:
planning means for receiving a request model, which is change prediction information of a request to a system and changing a scaling point, which is a configuration of said system which satisfies a condition for each of periods of said request model based on a predetermined rule,
scaling cost calculation means for calculating a scaling cost, which is a cost required for changing said scaling point and outputting said scaling cost, and
performance calculation means for calculating a performance value, which is a value representing a performance of the system when said scaling point is changed by said planning means and outputting said performance value.
